(19) United States
(12) Patent Application Publication
(10) Pub. No.: US 2018/0035374 A1
(43) Pub. Date: Feb. 1, 2018

(54) LOCKSTEP NETWORKING

(71) Applicant: GTHRIVE, INC, Santa Clara, CA (US)

(72) Inventors: Bruce S. BORDEN, Nevada City, CA (US); Joop C. VERBAKEN, Palo Alto, CA (US); Bradford COTTEL, Woodacre, CA (US)

(21) Appl. No.: 15/549,876

(22) PCT Filed: Feb. 9, 2015
(86) PCT No.: PCT/US15/15015

§ 371 Date: Aug. 9, 2017

(51) Int. Cl. H04W 52/02; H04L 12/823; H04W 28/02; H04W 56/00; H04L 12/26; H04W 24/10

(52) U.S. Cl. CPC H04W 52/0229; H04L 43/10; H04W 24/10; H04W 28/0278; H04W 56/001; H04L 47/32

(57) ABSTRACT

Exemplary methods, apparatuses, and systems configure a recurring heartbeat for a first field device to operate in synchronization with a second field device and a base station. The first field device turns off radio power for a hibernation period. Upon the beginning of a heartbeat, the first field device samples a sensor value and stores a report in a report buffer. The report includes the sensor value, identification of the first field device, identification of the report, and a circle number representing a number of intervening field devices in a communication path between the first field device and the base station. The first field device powers on the receive radio and receives a report from the second field device. The first field device transmits one or more reports stored in the report buffer, and powers off the radios for another hibernation period.

### FIELD

The various embodiments described herein relate to devices communicating via a wireless network protocol. In particular, embodiments relate to low duty cycle battery-operated wireless devices communicating in lockstep within one another and minimizing power consumption.

### BACKGROUND

Wireless local area networks and personal area networks utilize a variety of protocols. These protocols often attempt to achieve the goal of minimizing power consumption for at least some devices within the network. For example, ZigBee is a network protocol designed for low power digital radios based upon the Institute of Electrical and Electronics Engineers (IEEE) 802.15.4 standard. ZigBee assigns devices within the network to the following device types: coordinator, router, and end device. The coordinator is at the root of the network tree. Routers, in addition to other functions, receive and repeat transmissions from other devices in the network. End devices transmit data to and/or receive data from a parent node (e.g., a router or the coordinator). End devices do not relay transmissions from other devices. Accordingly, routers typically remain turned on continuously, keep their receivers active and transmit more often than end devices, resulting in greater power consumption. Applications of ZigBee, and similar protocols, minimize power consumption in battery-operated devices by relying on devices coupled to mains power (e.g., an alternating current (AC) electric power source) or another significant electric power source (e.g., large batteries coupled to one or more solar panels or another generator of electricity) to serve as routers, while delegating battery-operated devices to the role of end device. Extending the range of the network beyond the reach of the coordinator is therefore dependent upon the inclusion of one or more always-on routers. Agricultural fields and other environments, however, lack access to mains power. If a battery-operated device were to be assigned the router device type, the range of the network would be extended at the cost of a greater demand on the device's battery power due to the amount of power consumed by routing overhead, using the transmit radio to repeat all received messages, constantly powering the receive radio to listen for messages, etc.

### BRIEF DESCRIPTION OF THE DRAWINGS

Non-limiting and non-exhaustive embodiments are described with reference to the following figures, wherein like reference numerals refer to like parts throughout the various views unless otherwise specified:

FIG. 1 illustrates, in block diagram form, an exemplary lockstep network according to one embodiment;

FIG. 2 illustrates, in block diagram form, the exemplary lockstep network with field devices relocated;

FIG. 3 is a flow diagram illustrating an exemplary method of lockstep networking including server configuration of a base station for pairing field devices and server receipt of report data from a base station;

FIG. 4 is a flow diagram illustrating an exemplary method of lockstep networking including the base station processing pairing requests and/or reports from field devices;

FIGS. 5A-5B are a flow diagram illustrating an exemplary method of lockstep networking including a field device pairing with the base station, reporting sensor data, processing an acknowledgment, and hibernating during a heartbeat;

FIG. 6 is a timing diagram illustrating exemplary heartbeats, each heartbeat including a reporting period and a hibernation period;

FIG. 7 is a timing diagram of an exemplary reporting period of a heartbeat;

FIG. 8 is a timing diagram of radio activity among multiple devices within the lockstep network during corresponding reporting periods; and

FIG. 9 illustrates, in block diagram form, an exemplary processing system to implement lockstep networking.

### DETAILED DESCRIPTION

Embodiments described herein include each of multiple battery-operated field devices configuring a recurring heartbeat to synchronize limited communication with a base station and one another. For example, a field device may receive an indication of time and an indication of the heartbeat interval from the base station. The field device configures the clock to run in synchronization with the base station (and other field devices) based upon the indication of time received from the base station. The field device configures the recurring heartbeat period based upon the indication of the heartbeat interval and the clock.

Each field device turns off radio power for a hibernation period. For example, each heartbeat includes a minimal active period and a comparatively longer hibernation period. Upon the beginning of the next heartbeat, a field device samples a sensor value and stores a report in a report buffer. The report includes the sensor value, identification of the field device, identification of the report, and a circle number representing a number of intervening field devices in a communication path between the field device and the base station.

Each field device powers on the receive radio during a waiting period of the heartbeat in order to receive reports from other field devices (if any). The length of the waiting period is based upon the field device's circle number. For example, each field device calculates a period of time sufficient to enable other field devices in outer circles to transmit their reports. Received reports may also be added to the field device's report buffer. For example, non-duplicative reports received from other field devices with a larger circle number are added to the report buffer.

The field device powers on the transmit radio, transmits one or more reports stored in the report buffer. For example, the field device transmits its own report and relays any non-duplicative reports received from other field devices with a larger circle number. Upon receiving and, if applicable, retransmitting any acknowledgments of the one or more reports, the field device powers off the radios for another hibernation period.

As a result, battery-operated devices are able to extend a wireless network, relaying reports to and acknowledgments from the base station, while minimizing the amount of time the devices are awake, minimizing the transmission of data, and consuming a minimal amount of power. In particular, a wireless network may be established among battery-operated devices in an environment in which access to mains power is limited or non-existent. For example, embodiments of the lockstep wireless network protocol may be implemented by agricultural field sensor devices that do not have access to a mains power supply. These battery-powered agricultural field sensor devices are able to relay communications between a base station and other agricultural field sensor devices, extending the range of the lockstep network to cover an area, e.g., of one or more miles in radius. Additionally, the agricultural field sensor devices may be enclosed in a housing in a manner to prevent water ingress, which hinders or prevents changing and/or recharging batteries. The lockstep wireless network protocol provides a robust network that is simple to implement and minimizes power consumption such that a user may avoid changing or recharging batteries within the devices even after years of operation.

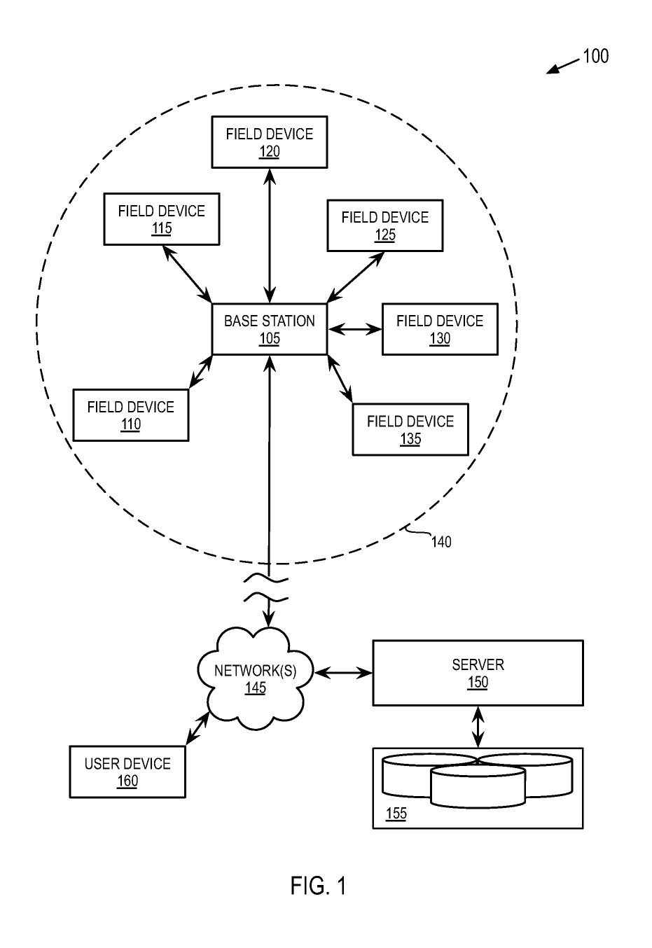

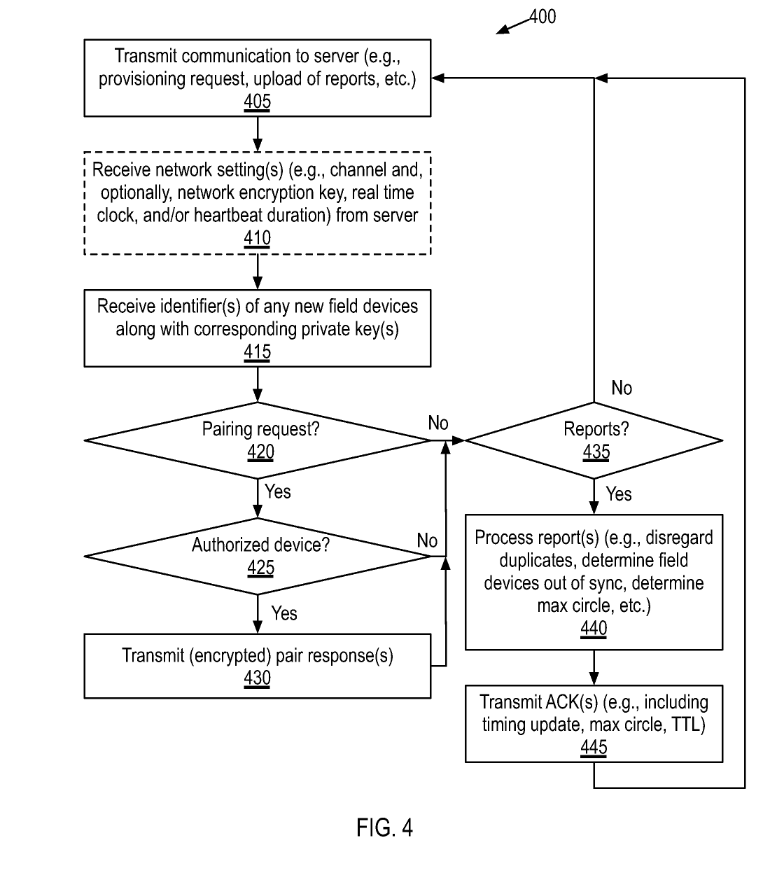

FIG. 1 illustrates, in block diagram form, exemplary lockstep network 100 according to one embodiment. Lockstep network 100 includes base station 105 and field devices 110-135 within wireless range 140 of base station 105. In one embodiment, base station 105 is powered via mains power (e.g., an alternating current power supply), solar panel and battery pack, or another power supply. In one embodiment, field devices 110-135 are battery-operated devices that include one or more sensors. For example, field devices 110-135 may include sensors to measure light, temperature, moisture, electrical conductivity, movement, etc. Field devices 110-135 sample sensor data from the one or more sensors and transmit the sensor data to base station 105. Base station 105 and field devices 110-135 communicate via a low power wireless networking protocol, e.g., based upon IEEE 802.15.4, IEEE 802.11, IEEE 802.15.1, etc. Communication between field devices 110-135 and base station 105 is described further with reference to FIGS. 4-8.

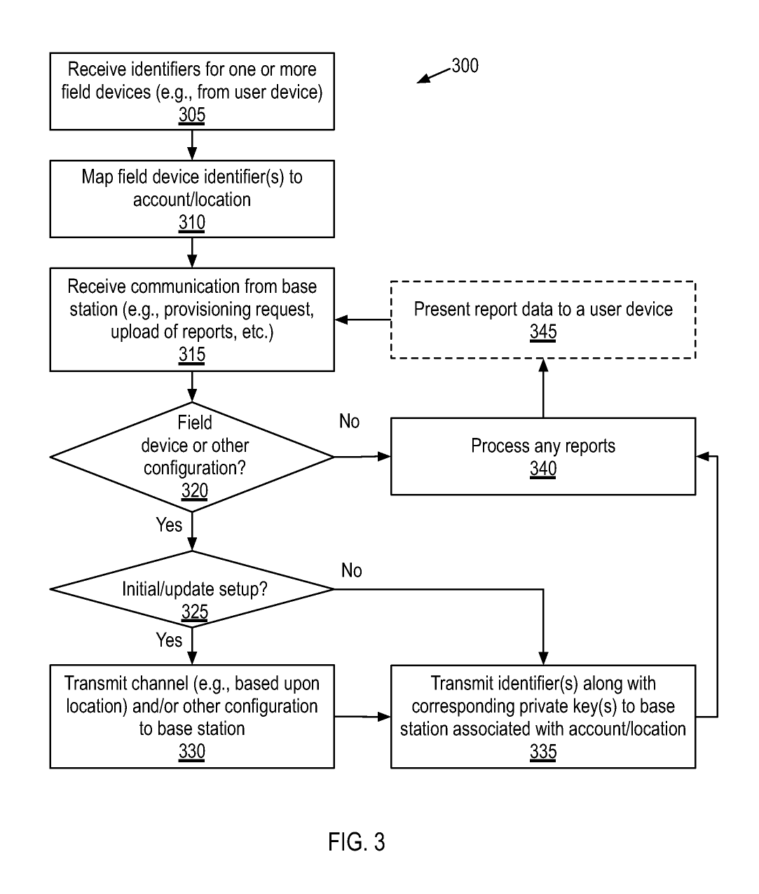

Base station 105 is coupled to network(s) 145, e.g., a local area network and/or a private or publically accessible wide area network, such as the Internet. For example, base station 105 may be coupled, via a wireless (e.g., IEEE 802.11, cellular, etc.) or wired connection, to a network-connected cell site or router (not illustrated). Base station 105 communicates, via network(s) 145, with server 150. For example, base station 105 transmits the sensor data received from field devices 110-135 to server 150. Server 150 stores the sensor data in attached storage 155 and generates corresponding reports, notifications, etc. to be accessed via user device 160. Additionally, server 150 transmits configuration data to base station 105. For example, server 150 may receive an indication of new field devices, a network encryption key, or other configuration data from user device 160. Server 150 transmits the corresponding configuration data, such as field device identifiers, encryption keys, etc., to base station 105. Lockstep network configuration and communication between base station 105 and server 150 is described further with reference to FIGS. 3-4.

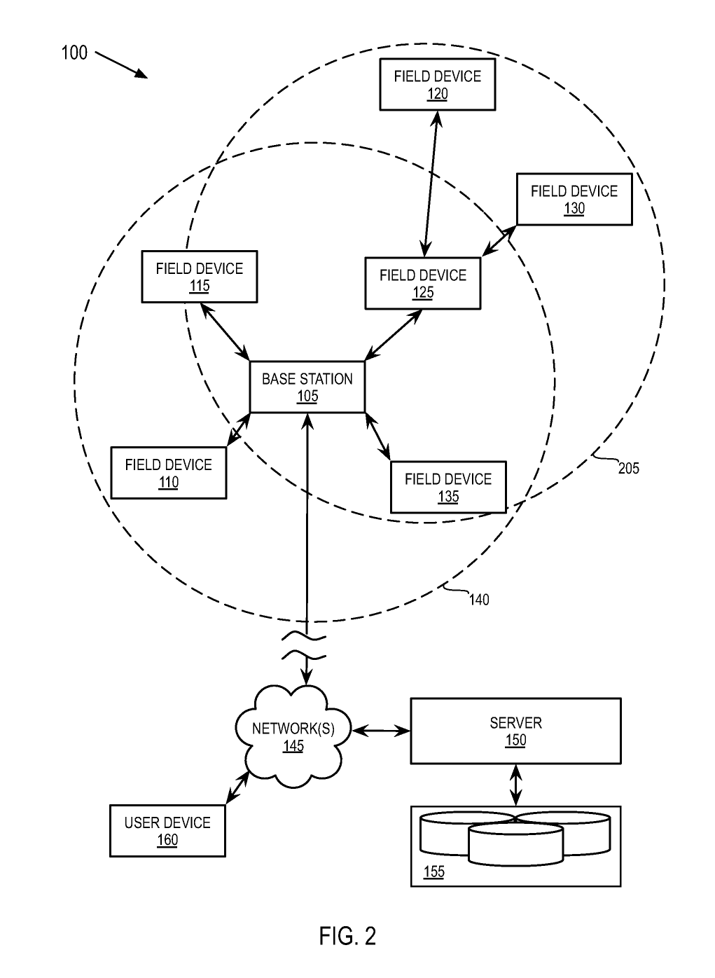

Field devices 110-135 are configured to operate using one or more circle numbers as indication of a number of intervening field devices 110-135 within a communication path between a given field device and base station 105. For example, FIG. 1 illustrates field devices 110-135 all within wireless range 140 of base station 105. In other words, each of field devices 110-135 is able to communicate directly with base station 105. Given that there are no intervening field devices in the communication path between field devices 110-135, each of field devices 110-135 is set to use circle number one. In an alternate embodiment, another number is used for the first circle. For example, the first circle may be referred to as circle number zero. Field device circle numbers are described further with reference to FIGS. 2 and 4-8.

FIG. 2 illustrates, in block diagram form, exemplary lockstep network 100 with field devices 120 and 130 relocated outside of wireless range 140 of base station 105. Relocated field devices 120 and 130 are instead within wireless range 205 of field device 125. As a result, field devices 120 and 130 rely on one intermediate field device, field device 125, to communicate with base station 105. Upon discovering field devices 120 and 130 receive communications via one other field device, field devices 120 and 130 update their respective circle numbers to reflect being in the second circle. Following the example above, field devices 120 and 130 may use circle number two. Similarly, if a field device were located such that one of field devices 110, 115, or 135 were an intermediate field device in the communication path between base station 105 and the field device, the field device would also use circle number two. Additionally, if a field device were to receive communications via relocated field device 120, that field device would use circle number three. Field device circle numbers are described further with reference to FIGS. 4-8.

FIG. 3 is a flow diagram illustrating exemplary method 300 of lockstep networking including server configuration of a base station for pairing field devices and server receipt of report data from a base station. At block 305, the server receives one or more identifiers for one or more field devices. For example, a user may purchase field devices 110-135 and wish to configure field devices 110-135 to communicate with base station 105. The user, via user device 160, transmits a unique identifier for each/the set of field devices 110-135 to server 150. In one embodiment, the user manually enters the/each unique identifier. In another embodiment, user device 160 scans a code (e.g., a quick response (QR) code or another bar code) on the field devices, device packaging, or device documentation, translates the code into the unique identifier(s), and transmits the unique identifier(s) to server 150. In an alternate embodiment, one or more field devices 110-135 transmit a unique identifier to user device 160, e.g., via radio frequency identification (RFID), near field communication (NFC), or a similar communication protocol.

At block 310, the server maps the field device identifier(s) to an account and/or location associated with the user. For example, the user may have logged into server 150 with credentials linked to a user account/profile. The user account may include an indication of a location where field devices 110-135 are to be used or a location of base station 105. In one embodiment, user device 160 transmits (e.g., along with the transmission of the unique identifier(s)) an indication that field devices 110-135 are to be used with base station 105. For example, user device 160 may display one or more base stations associated with the user account and receive selection of base station 105 to serve as the base station for field devices 110-135. In one embodiment, in addition to the transmission of the unique identifier(s), user device 160 transmits location data indicating a location in which field devices 110-135 are to be used and/or a location of base station 105 with which field devices 110-135 are to be used. For example, user device 160 may automatically transmit a current location of user device 160 (based upon global positioning system (GPS) data or similar location data). As another example, user device 160 may transmit the indication of location in response to user selection of a location on a map displayed on user device 160, user entry of GPS coordinates or other location data in an input field, or another manual entry of location data.

At block 315, the server receives a communication from base station. For example, the communication may be a provisioning/configuration request, an upload of reports received from field devices, etc. In one embodiment, a base station transmits a request for configuration in response to detecting a lack of configuration (e.g., upon an initial power up of the base station). In one embodiment, a base station periodically transmits a request for configuration updates. In another embodiment, the server pushes configuration data to the base station (e.g., bypassing block 315).

At block 320, the server determines if the base station is to be configured to communicate with any new field devices or otherwise to setup lockstep network settings. For example, server 150 may determine that it has received and mapped field devices 110-135 to base station 105 as described above with reference to blocks 305-310 and not yet configured base station 105 to communicate with field devices 110-135.

If the base station is to be configured to communicate with any new field devices, at block 325, the server determines if the base station to be configured (or reconfigured) for any lockstep network settings. For example, server 150 may determine base station 105 has yet to be assigned (or is to be reassigned) a wireless channel, network encryption key, real-time clock, heartbeat duration, and/or other settings used to communicate and synchronize with field devices 110-135.

If the base station is to be configured (or reconfigured) for any lockstep network settings, at block 330, the server transmits a wireless channel and/or other initial configuration data to the base station. For example, server 150 determines a wireless channel based upon the location of base station 105 to prevent interference with wireless communications of neighboring lockstep networks (which may be configured to communicate via different wireless channels). Server 150 transmits the determined wireless channel to base station 105. In one embodiment, server 150 transmits a network encryption key or other initial configuration data to base station 105. For example, server 150 may determine or select a network encryption key randomly or associated with a corresponding user account or location and transmit the encryption key to base station 105.

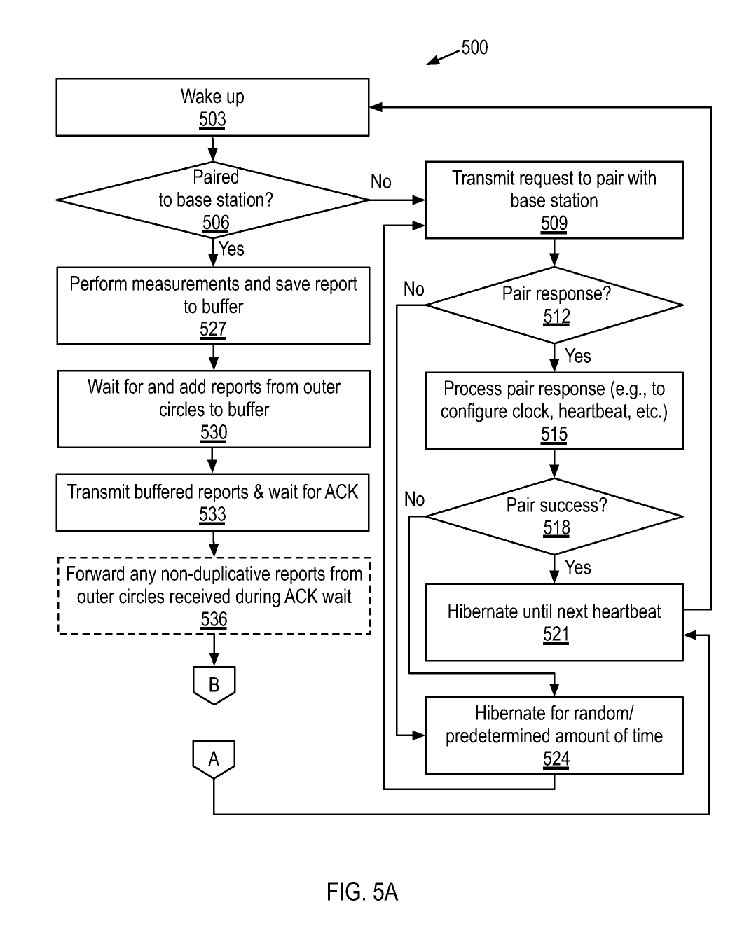

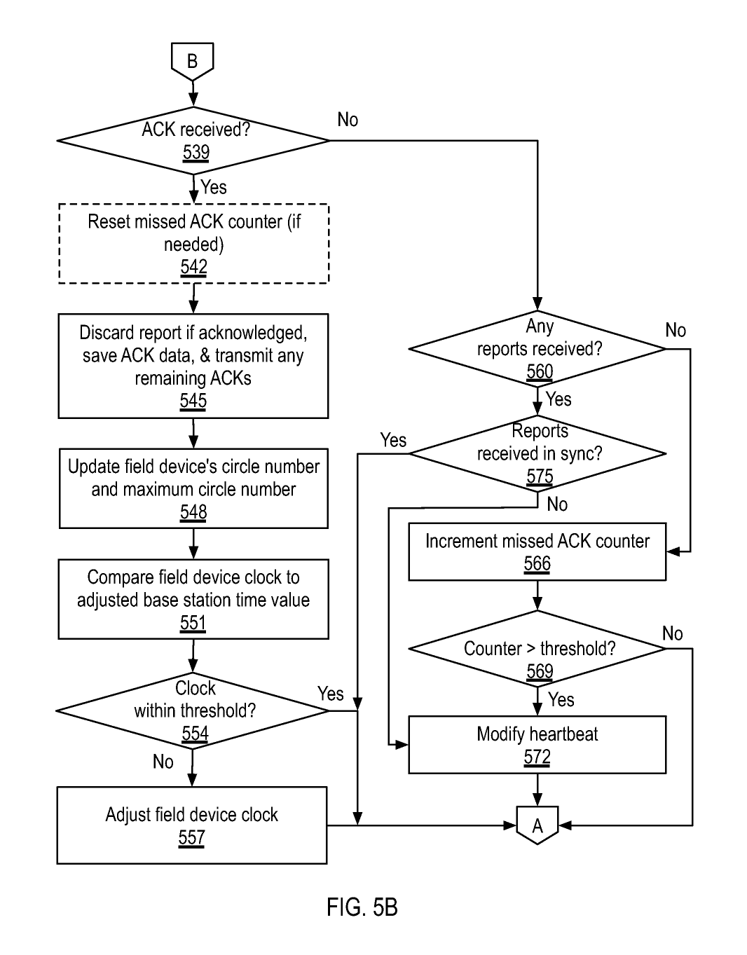

When the base station has been configured (or reconfigured) for the lockstep network settings, at block 335, the server transmits unique identifiers for the one or more field devices to the base station associated with the user account and/or location associated with the field device(s). For example, in response to determining base station 105 has yet to be configured to communicate with field devices 110-135, server 150 transmits media access control (MAC) addresses or another unique identifier for each of field devices 110-135. In one embodiment, server 150 further transmits private encryption keys for each of field devices 110-135 for pairing base station 105 with field devices 110-135 (as described further with reference to FIG. 5A).

At block 340, the server processes any reports received from the base station. For example, base station 105 may transmit the sensor data received from field devices 110-135 to server 150. Server 150 generates one or more cumulative reports and/or user notifications based upon the sensor data and stores the report data, cumulative reports, and/or user notifications within attached or cloud-based storage 155.

At block 345, the server optionally presents the report data to a user device. For example, in response to receiving a request from user device 160, server 150 retrieves the report data, cumulative reports, and/or user notifications stored within attached storage 155 and transmits them to user device 160 for display to a user. In one embodiment, the server processes data as it arrives from one or more base stations and warns a user of problems. For example, server 150 may generate warnings regarding weather conditions (e.g., a frost warning), water conditions (e.g., excess water), a base station or field device has failed, etc.

Method 300 returns to block 315 to receive and process additional communications from the base station until additional identifiers for field devices are received.

FIG. 4 is a flow diagram illustrating exemplary method 400 of lockstep networking including the base station processing pairing requests and/or reports from field devices. At block 405, the base station transmits a communication to the server. For example, as described above, the communication may be a provisioning/configuration request, an upload of reports received from field devices, etc.

At block 410, the base station optionally receives lockstep network settings. For example, base station 105 receives from server 150 one or more of: a wireless channel, network encryption key, real-time clock, heartbeat duration, and/or other settings used to communicate and synchronize with field devices 110-135. In one embodiment, base station 105 communicates with field devices via a protocol that does not utilize channels. Alternatively, server 150 assigns a communication channel to base station 105, as described further below. In one embodiment, base station 105 utilizes Network Time Protocol (NTP) to set and maintain its real-time clock. For example, base station 105 may set, update, or otherwise adjust its real-time clock periodically, when its real-time clock differs by a threshold amount from time as represented by server 150, etc.

At block 415, the base station receives identifiers of any new field devices (i.e., zero or more) to be added to a lockstep network with the base station. For example, as described above, the server maps field device identifier(s) to an account and/or location associated with the user and transmits the field device identifier(s) to the base station associated with the user account and/or corresponding location.

At block 420, the base station determines if the base station has received a pairing request from a field device. For example, the pairing request may include the unique identifier of the field device and an indication that the field device is requesting to pair with a base station.

If the base station has received a pairing request, at block 425, the base station determines if the pairing request was received from an authorized field device. For example, the base station may compare the unique identifier of the field device received within the pairing request to one or more unique identifiers received from the server. Alternatively, the base station may transmit the unique identifier of the field device received within the pairing request to the server and receive an indication, from the server in response, of whether or not the pairing request was received from an authorized field device. As a result, only field devices owned by the user or otherwise authorized by the user account/location associated with base station are able to pair with the base station.

If the pairing request was received from an authorized field device, at block 430, the base station transmits a pairing response to the field device. For example, the base station broadcasts a pairing response including one or more of: a message type indicating that the message is a pairing response, the unique identifier of the field device, a time stamp for the field device to use in setting a real-time clock, a heartbeat interval/period, a maximum hop count, a hop count, a node number for the field device, the lockstep network encryption key, and/or the network radio channel. The time stamp includes one or more values representing the current time in year, month, day, hour, minutes, seconds, and milliseconds. The heartbeat period may be a length of time each recurring heartbeat, a number of heartbeats to occur in a given period of time (e.g., per day), a modulo of the clock with midnight serving as zero, etc. The maximum hop count represents a threshold number for circle numbers and a maximum number of times a message will be transmitted. The hop count is decremented each time a message is received and the message is not retransmitted if the maximum hop count is decremented to zero. If the maximum hop count is ten and the hop count is set to the maximum, the message will be transmitted ten times at most, including the original transmission by the base station and up to nine retransmissions by field devices. In one embodiment, the base station sets the hop count to one when transmitting a pairing response. As a result, field devices would need to be within wireless range of the base station to pair (rather than rely on retransmission from another field device). Each node number uniquely identifies a field device within a lockstep network and is shorter than the field device's unique identifier.

In one embodiment, the pairing request and pairing response are transmitted over a default radio channel. For example, the base station may continually monitor the default radio channel whether or not the base station is a part of a lockstep network with field devices that communicate via another radio channel. Additionally, field devices may transmit and receive via the default radio channel until instructed via a paring response to utilize a different radio channel.

In one embodiment, the pairing request and pairing response are encrypted using the field device's private encryption key. For example, the base station receives each authorized field device's private encryption key along with the corresponding unique identifiers (e.g., as described with reference to block 415). The unique identifier included in the pairing request is not encrypted and used by the base station to look up the corresponding private encryption key received from the server. The base station decrypts a remainder of the pairing request using the private encryption key. In one embodiment, the encrypted portion of the join request includes a “secret” (e.g., a random number) generated by the field device. The base station decrypts the secret and includes the secret in the pairing response. The base station broadcasts the pairing response with the field device's unique identifier not encrypted and a remainder of the pairing response encrypted with the field device's private encryption key. The field device may compare the secret received from the base station to a stored copy of the secret transmitted in the pairing request to verify the pairing response.

If the base station has not received a pairing request, has received a pairing request from an unauthorized device, or has paired with an authorized device, at block 435, the base station determines if the base station has received any reports from field devices. If the field device has received no reports, method 400 returns to block 405. Alternatively, method 400 returns to block 420 for a threshold amount of time/cycles before returning to block 405.

In one embodiment, if the base station has received a pairing request from an unauthorized device, the base station transmits an indication of or data from the pairing request to the server. For example, the server may generate an alert or other notification for the user associated with the base station regarding the unauthorized pairing request.

If the base station received one or more field device reports, at block 440, the base station processes the report(s). For example, each field device may transmit a report including sampled sensor data representing one or more of light, temperature, moisture, electrical conductivity, movement, etc. measured by the field device. The base station may in turn transmit the sampled sensor data to the server for the generation of cumulative reporting, notifications, etc. Additionally, the base station extracts the field device node number (or unique identifier) from each report to create an acknowledgment list.

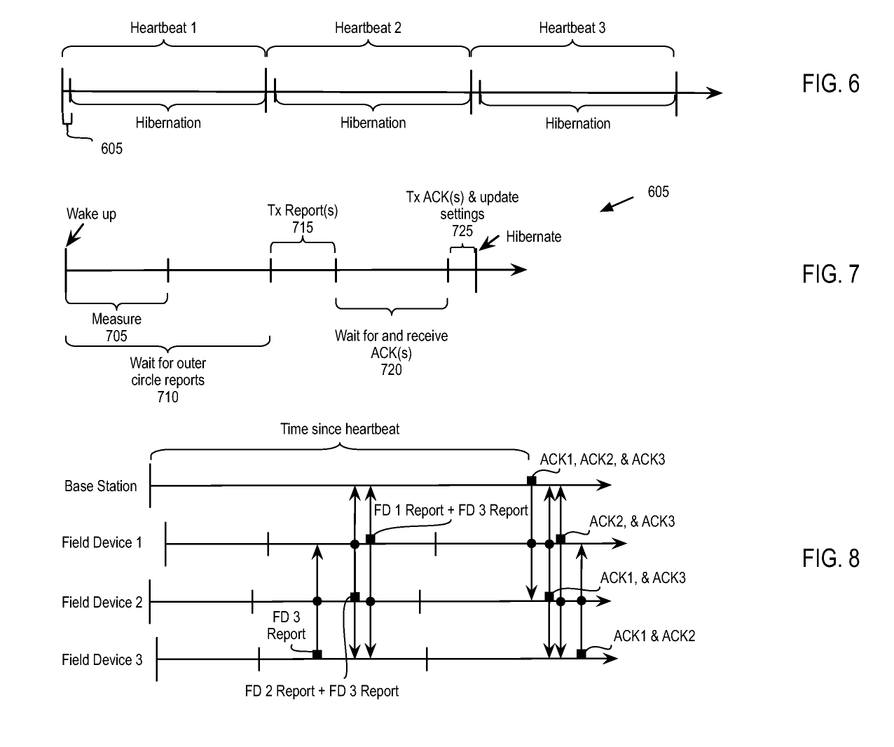

In one embodiment, the base station determines if any field devices are out of sync with the lockstep networking heartbeat. For example, the base station may detect that a report is received outside of an expected time window. In response to detecting a field device that is out of sync, the base station responds with a new pairing response to resynchronize the field device. In one embodiment, if the base station detects a field device failing out of sync a threshold number of times, the base station transmits an indication of a problem (e.g., such as a bad real-time clock) to the server. The heartbeat, timing, and synchronization of the lockstep network is described further herein with reference to FIGS. 6-8.

In one embodiment, the base station transmits, to the server, an indication of missed reports (if any) from field devices paired with the base station. For example, after pairing with the base station, a field device may have failed, fallen out of sync with the lockstep network heartbeat, or otherwise lost communication with the base station (and other field devices) due to being positioned out of range of other devices, having communications blocked by a large object (e.g., a tractor), etc. In such an instance, the base station will expect to receive reports from the field device based upon the previous pairing within a window of time (e.g., within the heartbeat). The base station transmits a notification of one or more missed reports (e.g., each missed report, when a consecutive threshold number of missed reports from a field device is reached, etc.) to the server.

In one embodiment, the base station discards any duplicates of field device reports. For example, multiple field devices may receive and repeat a report from a field device with a greater circle number. As a result, the base station may receive multiple copies of the same report. In one embodiment, the base station compares device identifier and report identifier pairs included in each field device report to detect and discard of duplicate reports. The detection and discarding of duplicate reports is described further herein with reference to FIGS. 5A and 8.

In one embodiment, the base station determines the current maximum circle number based upon the field device reports. For example, each field device report may include the circle number of the reporting field device. As described further herein, field device circle numbers may change due to changed locations and/or communication paths used by the field devices. Based upon the reports received during a given heartbeat, the base station compares the respective circle numbers and selects a maximum circle number.

At block 445, the base station transmits an acknowledgment message including an acknowledgment list of each received field device report. For example, the base station transmits the acknowledgment list including the field device node numbers from which the base station received report. In one embodiment, the acknowledgment message further includes one or more of: a message type indicating that the message is an acknowledgment, a hop count (or time to live (TTL) value) set to the maximum hop count, the current maximum circle number, and an indication of the base station's real-time clock. In one embodiment, the indication of the base station's real-time clock is the amount of time that has passed following the beginning of the current heartbeat. For example, the base station tracks or otherwise determines the amount of time that has passed from the beginning of each heartbeat to the transmission of the acknowledgment list. Alternatively, the indication of the base station's real-time clock is the current time reflected by the real-time clock.

In one embodiment, the base station performs at least some of the report processing after transmitting the acknowledgment list. For example, the base station may remove duplicate reports and transmit data to the server after transmitting the acknowledgment list to reduce the amount of time the field devices need to power receive radio(s) to wait for acknowledgments.

FIGS. 5A-5B are a flow diagram illustrating exemplary method 500 of lockstep networking including a field device pairing with the base station, reporting sensor data, processing an acknowledgment, and hibernating during a heartbeat. At block 503, the field device wakes up. For example, the field device may wake up when initially powered on, or in response to detecting the beginning of a heartbeat or the end of a hibernation period. Hibernation, as used herein, refers to a low power state in which the field device turns off power to multiple components of the field device. For example, during hibernation, the field device does not provide power to sensors (e.g., moisture, light, etc.), to a receive radio, to a transmit radio, etc. In one embodiment, when the field device wakes up, it does not restore power to all components immediately. For example, the field device may continue to operate in a low power state without powering receive and transmit radios until ready to receive or transmit messages.

At block 506, the field device determines if the field device has been paired with a base station. For example, the field device may store a binary state of being paired or not being paired with a base station. If has not been paired with a base station, at block 509, the field device broadcasts a pairing request. The pairing request is transmitted on the default radio channel and includes one or more of: a message type indicating that the message is a pairing request, the unique identifier for the field device, and/or a secret. As described herein, the field device encrypts at least a portion of the pairing request using the field device's private encryption key. In one embodiment, the field device stores a copy of the secret to be used to verify a pairing response.

At block 512, the field device determines if the field device has received a pairing response from a base station. In one embodiment, the field device waits for a threshold period of time for a pairing response. If the field device has received a pairing response from a base station, at block 515, the field device processes the pairing response. For example, the field device confirms that its own unique identifier is included in the pairing response, decrypts (if encryption is used) the encrypted portion of the pairing response using its private encryption key, verifies the secret returned by the base station matches the secret the field device transmitted in the pairing request, stores a copy of the maximum hop count, stores a copy of the node number assigned by the base station (e.g., to be used in place of the longer unique identifier), stores a copy of the lockstep network encryption key for encrypting and decrypting communications with other nodes in the lockstep network, sets the transmit and receive radios to the received network radio channel, and saves and configures its clock and heartbeat interval based upon the timing data in the pairing response.

As described above, the pairing response may include a time stamp of the base station's real-time clock at the time the base station transmits the pairing response. The field device uses this time stamp to synchronize its own clock with the base station's clock. In one embodiment, the field device adjusts the time for the delay of processing and transmitting the time stamp. For example, the field device starts a timer with the transmission of the pairing request and ends the timer with the receipt of the pairing response. As a result, the field device determines a round trip time (e.g., in milliseconds) for transmissions to be sent to and returned from the base station. The field device divides the round trip time in half as an estimate of the amount of time that has passed following the base station's transmission of the pairing response. For example, the estimated processing and transmission time may account for six to seven milliseconds when transmitting at 2.4 GHz using IEEE 802.15.4. The field device adds this estimated processing and transmission time to the received timestamp and sets the field device's clock to the sum. Additionally, the field device stores the estimated processing and transmission time for use in determining wait periods for transmissions, as described further herein.

As described above, the pairing response may include a modulo of a twenty four hour clock (e.g., with midnight serving as zero) or another indication of an interval to set the heartbeat. The field device uses the indication of the heartbeat interval and the synchronized field device clock to establish a heartbeat interval for the field device that is synchronized with a heartbeat interval used by the base station and other field devices paired with the base station.

In one embodiment, field devices need to be within wireless range of the base station to pair (rather than rely on retransmission from another field device). In other words, each field device pairs with the base station without any intermediate field devices in the communication path to the base station. As a result, each field device sets its circle number to one (following the circle numbering example above) as a default value when successfully paired with a base station. For example, referring to FIG. 1, field devices 110-135 are all within wireless range 140 of base station 105 when paired with base station 105. Accordingly, each of field devices 110-135 sets its respective circle number to one. A field device may update its circle number based upon a received acknowledgment indicating one or more intermediate field devices in the communication path between that field device and the base station. The determination and updating of a circle number is described further with reference to FIG. 5B.

At block 518, the field device determines if the field device successfully paired with the base station. For example, the field device confirms that its own unique identifier is included in the pairing response and verifies the secret returned by the base station matches the secret the field device transmitted in the pairing request. If the field device received a pairing response with the correct unique identifier and, if used, with the correct secret, at block 521, the field device enters a hibernation mode until the beginning of the next heartbeat, at which time the field device wakes up again (at block 503).

If the field device has not received a pairing response with the correct unique identifier and, if used, with the correct secret, at block 524, the field device discards the pairing response and hibernates for a random or predetermined amount of time before transmitting another pairing request at block 509. Alternatively, when the field device receives a pairing request with the correct unique identifier but the incorrect secret, the field device discards the pairing response and immediately transmits another pairing request at block 509. Similarly, if no pairing response is received, at block 524, the field device hibernates for a random or predetermined amount of time and returns to block 509 to broadcast another pairing request.

If the field device is paired with a base station, at block 527, the field device samples one or more sensor values and generates a report upon waking up. For example, the field device may sample one or more sensors to measure light, temperature, moisture, electrical conductivity, and/or movement. The field device formats a report including the sampled values and one or more of: a message type indicating that the message is a field device report, the field device's node number (or unique identifier), a message identifier (e.g., a sequence number or other identifier to differentiate messages from a single sender), a hop count, a maximum circle number, and the field device's circle number. In one embodiment, at least a portion of the report (e.g., including the sampled values) is encrypted using the lockstep network encryption key. The field device adds the generated report to a report buffer for later transmission.

At block 530, the field device waits to receive and adds received reports from field devices in outer circles to the report buffer. For example, the field device determines a waiting period to account for transmission and processing time for devices in outer circles to transmit reports. In one embodiment, the waiting period is set based upon the field device's circle number, a current maximum circle number (received from the base station during the previous heartbeat), and a wait interval. For example, the field device may determine the waiting period to be the wait interval multiplied by the difference between the maximum circle number and the field device's circle number (Wait Interval*(Max Circle−Field Device Circle)). In one embodiment, the wait interval is set to the estimated processing and transmission time. For example, a field device that determined an estimated processing and transmission time of seven milliseconds, received a maximum circle number of three from the base station, and determined its own circle number to be one will calculate a waiting period of fourteen milliseconds (7 ms*(3−1)=14 ms). In another embodiment, the wait interval is set to a multiple of the estimated processing and transmission time or another predetermined amount of time. In one embodiment, the waiting period is measured from the start of a heartbeat.

In one embodiment, the field device turns on power to the receive radio in response to completing the sampling of sensors or generating a report including sensor data. In another embodiment, the field device turns on power to the receive radio when it wakes up from hibernation.

In one embodiment, the field device compares circle numbers in reports received from other field devices to its own circle number. For example, the transmitting field device includes its circle number in the report being processed by the receiving field device. If the circle number included in the report is equal to or less than the receiving field device's circle number, the field device discards the report. Field devices in the same circle or a lesser circle are most likely within range of the base station or within range of a field device with a shorter communication path (e.g., a path with less intermediate nodes) than if the report were to be retransmitted by the receiving field device.

In one embodiment, the field device determines if any received reports duplicates. For example, multiple field devices with the same circle number may receive and retransmit a report broadcast by a field device in an outer circle. As such, a report message from another field device may include one or more reports from other field devices. Each report includes an identification of the reporting field device (e.g., a node number) and an identification of the report (e.g., a report sequence number). If the field device receives any reports including the same node number and sequence number pair as another report received during the heartbeat, the field device determines the report to be a duplicate and discards the duplicate report.

The field device adds received reports (that are not discarded) to the report buffer along with its own report. For example, the field device adds any non-duplicative reports received from field devices with a greater circle number than the receiving field device to the report buffer. In one embodiment, the field device determines a maximum circle number among received reports and updates the maximum circle number to be reported back to the base station.

At block 533, at the end of the waiting period, the field device transmits any reports stored in its report buffer. For example, the field device broadcasts a reporting message including its own report and any non-duplicative reports received from field devices with a greater circle number. In one embodiment, the field device discards other reports stored in the report buffer in response to transmitting the reporting message, saving only its own report to wait for an acknowledgment. In one embodiment, the field device stores an indication that one or more reports were received during the waiting period. For example, as discussed further below, the receipt of reports from field devices with greater circle numbers during the waiting period may serve as an indication that the transmitting and receiving field device are in sync with the heartbeat interval. The indication may include a number of reports received, or simply that one or more reports were received, during the waiting period. Additionally, in one embodiment, the field device may store an indication of whether discarded reports are received in or out of sync with the heartbeat interval. For example, the field device may receive a report from a field device with the same or lesser circle number during the waiting period indicating that the transmitting or receiving field device is out of sync. While the field device may not add a given report to its own transmission, the field device may determine whether or not the received report is in sync with the interval based upon the circle number included in the report and the time elapsed between the beginning of the heartbeat interval and the field device's receipt of the report. If the received report is not within a threshold amount of time of, e.g., the waiting interval multiplied by the circle number in the report, the field device determines that the report was received out of sync. In one embodiment, the field device powers on the transmitting radio in response to the end of the waiting period. Alternatively, the transmitting radio is powered on along with the receiving radio, but does not draw significant additional power unless transmitting.

In one embodiment, the field device determines an acknowledgment waiting period to wait for an acknowledgment of the report. For example, the field device determines a waiting period following the transmission of the one or more reports stored in the field device report buffer to account for transmission and processing time for the base station and field devices in inner circles (if any) to transmit the one or more reports and corresponding acknowledgments. In one embodiment, the waiting period is set based upon the field device's circle number and a wait interval. For example, the field device may determine the waiting period to be the wait interval multiplied by the field device's circle number (Wait Interval*Field Device Circle). In one embodiment, the wait interval is set to the estimated processing and transmission time. For example, a field device that determined an estimated processing and transmission time of seven milliseconds and determined its own circle number to be one will calculate a waiting period of fourteen milliseconds−a roundtrip for one circle. In another embodiment, the wait interval is set to a multiple of the estimated processing and transmission time or another predetermined amount of time.

At block 536, the field device optionally forwards reports received during the acknowledgment waiting period. For example, one or more field devices may be slightly out of sync with the heartbeat interval and transmit a reporting message after the receiving field device has transmitted its own reporting message. Alternatively, the receiving field device may be slightly out of sync with the heartbeat interval and, as a result, may receive synchronized reports outside of the waiting period. In one embodiment, the field device stores an indication that one or more reports were received after the waiting period. For example, as discussed further below, the receipt of reports from field devices (having a greater circle number) after the waiting period may serve as an indication that the field device is out of sync with the heartbeat interval. The indication may include a number of reports received or simply that one or more reports were received after the waiting period. In one embodiment, the receiving field device forwards non-duplicative reports received from field devices with a greater circle number during the acknowledgment period and discards duplicative reports or those received from field devices with a circle number less than or equal to the circle number of the receiving field device.

At block 539, the field device determines if the field device has received an acknowledgment message. As described above, an acknowledgment message includes an acknowledgment list including the field device node numbers from which the base station received report and one or more of: a message type indicating that the message is an acknowledgment, a hop count, the maximum circle number received by the base station during the current heartbeat, and an indication of the base station's real-time clock.

If the field device determines the field device has received a message having an acknowledgment message type and the acknowledgment list includes the field device's node number, at block 542, the field device optionally resets a missed acknowledgment counter. As described further below, the field device may track a number of missed acknowledgments to determine if the field device is out of synch or experiencing another problem.

At block 545, the acknowledgment list includes the field device's node number, the field device discards the acknowledged report stored in the report buffer and optionally removes the field device's acknowledgment from the acknowledgment list. If the acknowledgment list does not include the field device's node number, the field device saves the unacknowledged report in the report buffer and attempts to transmit the report again with a report generated in the next heartbeat. The field device saves the other contents of the acknowledgment message, decrements the hop count, and broadcasts the updated broadcast message if the message includes any remaining acknowledgments. For example, the field device saves the hop count, the maximum circle number, and the indication of the base station's real-time clock to adjust the field device's settings. In one embodiment, the field device only transmits the updated acknowledgment message if the hop count is greater than zero. In an alternate embodiment, each receiving field device increments the hop count and only transmits the updated acknowledgment message if the hop count is less than the maximum hop count.

In one embodiment, the field device discards duplicative acknowledgments. For example, the field device may receive acknowledgment messages from more than one node within the lockstep network during the acknowledgment waiting period.

At block 548, the field device updates its circle number and the current maximum circle number based upon the data from the acknowledgment message. The field device updates the current maximum circle number to the maximum circle value in the acknowledgment message. Additionally, the field device determines its current circle number based upon the saved hop count and maximum hop count. For example, the base station transmits an acknowledgment message with the hop count set to the maximum hop count value. Each time the acknowledgment message is received, the hop count is decremented. The field device receiving an acknowledgment message determines its current circle number by subtracting the saved hop count from the maximum circle number or maximum hop count value received within the acknowledgment message.

In an alternate embodiment, nodes increment the hop count and set their current circle number to the hop count. For example, the base station may transmit the acknowledgment message with a hop count set to zero and each receiving device may increment the hop count. A field device receiving the acknowledgment message directly from the base station would increment the hop count to one and set the field device's circle number to one. Another field device receiving the acknowledgment message in a communication path with one intermediate field device would increment the hop count from one to two and set its circle number to two.

Referring back to FIG. 2, field devices 120 and 130 have been moved outside of wireless range 140 of (or otherwise do not receive transmissions directly from) base station 105 but are within wireless range 205 of field device 125. Upon receiving an acknowledgement message from field device 125, field devices 120 and 130 each determine they are in circle number two based upon the hop count and maximum hop count in the acknowledgement message. For example, the base station transmits an acknowledgment message with the hop count set to the maximum hop count value. If the base station transmits the acknowledgment message with the maximum hop count set to ten, field device 125 receives the acknowledgment message directly from the base station and decrements the hop count and saves a hop count of nine. Field device 125 determines that the result of the maximum hop count, ten, minus the current hop count, nine, is the current circle number, one, for field device 125. Field device 125 transmits an updated acknowledgment message with the maximum hop count set to ten and hop count set to nine. Each of field devices 120 and 130 receives the acknowledgment message from field device 125 and decrements the hop count to eight. Each of field devices 120 and 130 determines that the result of the maximum hop count, ten, minus the current hop count, eight, is the current circle number, two, for field devices 120 and 130.

At block 551, the field device adjusts the indication of the base station's real-time clock received in the acknowledgment message. For example, the timing indication may be a time that has passed from the beginning of the current heartbeat or a current time stamp. The field device adds an estimated processing and transmission time (determined in a similar manner to the estimated processing and transmission time determined during pairing) to the received timing indication and compares the sum to the field device's own timer from the beginning of the heartbeat or the field device's clock.

At block 554, the field device determines if the field device's clock is within a threshold of synchronization with the base station. For example, if the field device began the heartbeat at a time or has a clock set to a time that is more than a threshold number of milliseconds different than that of the base station (as determined via the comparison with the adjusted timing indication), the field device is out of sync with the lockstep network.

If the field device is out of sync with the lockstep network, at block 557, the field device adjusts the field device's clock. For example, the field device may adjust a setting (e.g., a clock aging factor) to speed up or slow down the field device's clock. Alternatively, the field device may reset the field device's clock.

If the clock is within the threshold of synchronization with the base station, or after adjusting/resetting the field device's clock, the field device detects the end of the heartbeat and hibernates until the next heartbeat at block 521.

If the field device determines the field device has not received a message having an acknowledgment message type, at block 560, the field device determines if any reports were received from other field devices during the current heartbeat. For example, the field device may store an indication of any reports received during the heartbeat, whether those reports were added to the field device's own transmission or discarded. If the field device received no reports during the heartbeat interval, at block 566, the field device increments a missed acknowledgment counter. At block 569, the field device determines if the missed acknowledgment counter is greater than a threshold. If the missed acknowledgment counter is greater than a threshold, at block 572, the field device determines that the field device is out of synch with the lockstep network and modifies the field device's heartbeat period to attempt to receive future acknowledgment messages. For example, the field device may increase the length of each heartbeat. In one embodiment, the field device starts the next heartbeat a second early and ends the next heartbeat a second late. Alternatively, or if the field device remains out of sync with a modified heartbeat, the field device returns to an unpaired state and attempts to repair with the base station.

If the missed acknowledgment counter is not greater than a threshold, or after modifying the heartbeat, the field device detects the end of the heartbeat and hibernates until the next heartbeat at block 521.

If the field device received one or more reports during the heartbeat, at block 575, the field device determines if the reports were received in sync with the field device's heartbeat. As described above, the field device may store an indication of and/or count of in sync/out of sync reports received during the report waiting period or after the report waiting period. If the received reports were in sync with the heartbeat interval, the field device hibernates until the next heartbeat at block 521. If the received reports were out of sync with the heartbeat interval, at block 572, the field device modifies the field device's heartbeat period. Similar to the description above, the field device may increase the length of each heartbeat. In one embodiment, the field device starts the next heartbeat a second early and ends the next heartbeat a second late. Alternatively, or if the field device remains out of sync with a modified heartbeat, the field device returns to an unpaired state and attempts to repair with the base station. In one embodiment, the field device modifies its heartbeat in response to a threshold number of reports being received out of sync, a combination of reports being received out of sync and not receiving any acknowledgements, or a similar trigger condition. As a result, field devices are able to keep one another in sync with a common heartbeat interval even when the base station cannot. For example, a base station may lose power or otherwise be offline. While the base station is out of contact with the network, field devices continue to transmit reports and use one another's reports to maintain a common, synchronized heartbeat interval. When the base station comes back online, the base station may use the first set of reports to reset the base station clock and rejoin the synchronized heartbeat interval.

FIG. 6 is a timing diagram illustrating exemplary heartbeats, each heartbeat including a reporting period 605 and a hibernation period. As a result of the synchronized communication between nodes within the lockstep network during a heartbeat, field devices are able to minimize power consumption. For example, a field device may spend five minutes in hibernation and only be awake during reporting period 605 for measurements, receiving and transmitting reports, and receiving and transmitting acknowledgments for approximately 100 to 200 milliseconds (around 0.05% of the time within a heartbeat). For the sake of illustration, however, reporting period 605 is out of scale with the length of the heartbeat. Additionally, field devices may further limit power consumption during reporting period 605 by powering sensors and radios on and off as needed. For example, the field device may power on one or more sensors at the beginning of a heartbeat and power them off again once sampled. Additionally, the field device may wait to power on a receive radio after sampling the one or more sensors and wait to power on a transmit radio until after waiting for reports from outer circles.

FIG. 7 is a timing diagram of exemplary reporting period 605 of a heartbeat. As described above, the field device wakes up at the beginning of a heartbeat and the beginning of reporting period 605. Reporting period 605 will be described along the passage of time (e.g., as illustrated, from left to right). During an initial portion 705 of reporting period 605, the field device samples sensor values and generates a report. Additionally, the field device waits a determined waiting period 710 for reports from field devices in outer circles (if any). Upon the conclusion of waiting period 710, the field device transmits 715 the contents of its report buffer and waits another determined waiting period 720 for an acknowledgment message. Upon the conclusion of waiting period 720, the field device transmits 725 the updated acknowledgment message (if any acknowledgments remain and the hop count has not exceeded the threshold). Additionally, the field device updates settings and returns to hibernation until the next heartbeat.

FIG. 8 is a timing diagram of radio activity among multiple devices within the lockstep network during corresponding reporting periods. For example, field device 3 may be in an outermost circle, have a small or no wait period, and transmits a reporting message including only the report from field device three, FD 3 report. As illustrated, a square on the timeline represents the transmission of a reporting message and a circle or arrowhead represents the receipt of a reporting message. If field device 1 and field device 2 are both within broadcast range of field device 3 (and both have lesser circle numbers than field device 3), field devices 1 and 2 receive FD 3 report and add FD 3 report to their report buffers during their waiting period. As described above, field devices 1 and 2 have a longer waiting period than field device 3 prior to transmitting a reporting message. At the end of its waiting period, field device 2 transmits a reporting message including reports from both field device 2 and field device 3, FD 2 Report+FD 3 Report. Similarly, at the end of its waiting period, field device 2 transmits a reporting message including reports from both field device 1 and field device 3, FD 1 Report+FD 3 Report. Field devices 1 and 2 may be slightly out of sync with one another (but within an acceptable threshold). As a result, as illustrated, field device 2 transmits its reporting message prior to the field device 1. Field device 3 receives the reporting messages from field devices 1 and 2 and discards the reporting messages based upon a comparison of circle numbers (e.g., the circle number for field device 3 is greater than to the circle number for field device 1 and the circle number for field device 2). Similarly, field devices 1 and 2 discard each other's reporting messages based upon a comparison of circle numbers (e.g., the circle number for field device 1 is equal to the circle number for field device 2). The base station receives the reporting messages from field devices 1 and 2 and discards the duplicative copy of FD 3 report. For example, the base station receives the reporting message from field device 2 and saves FD 2 Report and FD 3 Report. The base station subsequently receives the reporting message from field device 1 and determines based upon a comparison of a node number and report sequence number pair that the reporting message from field device 1 includes a duplicate copy of FD 3 Report. As a result, the base station saves a copy of FD 1 Report and discards the duplicate copy of FD 3 Report. The base station generates an acknowledgment list including the node numbers for field devices 1, 2, and 3 in response to the received reports.

At the end of the base station's waiting period, the base station measures the amount of time since the beginning of the heartbeat and transmits an acknowledgment message including the acknowledgment list, ACK1, ACK2, & ACK3, and the time since the beginning of the heartbeat as described above. Field devices 1 and 2 receive the acknowledgment message broadcast from the base station. Each device optionally removes its own acknowledgment from the acknowledgment list and transmits an updated acknowledgement message. For example, field device 1 transmits an acknowledgment message including the acknowledgment list, ACK2 & ACK3. Field device 2 transmits an acknowledgment message including the acknowledgment list, ACK1 & ACK3. Having already received an acknowledgment message, field devices 1 and 2 discard each other's acknowledgment messages. Field device 3 receives the acknowledgment message from field device 2 and optionally removes its own acknowledgment. Field device 3 subsequently receives the acknowledgment message from field device 1. In one embodiment, field device 3 discards the subsequent acknowledgment and transmits the modified acknowledgment message from field device 2.

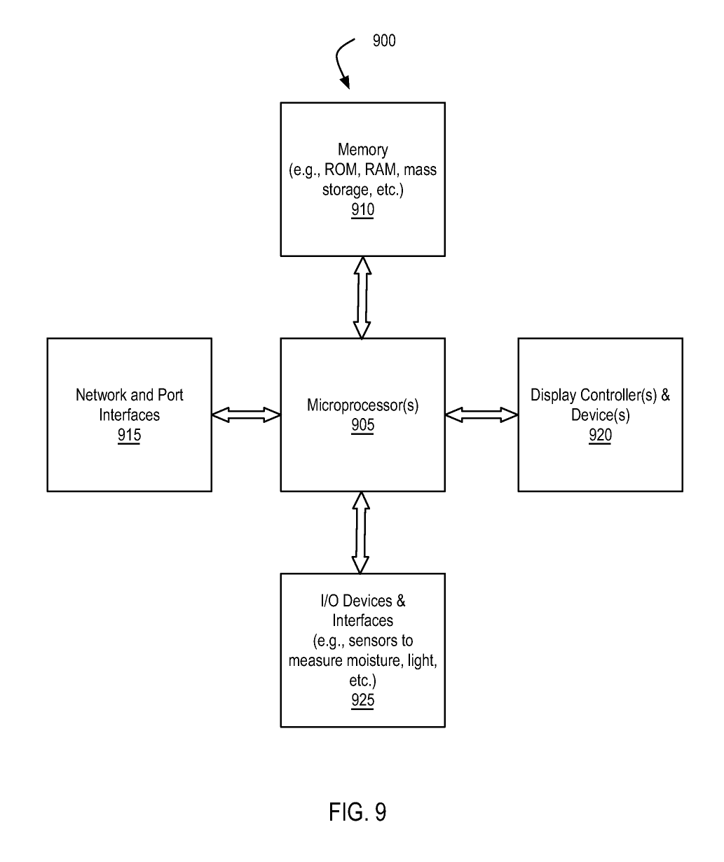

FIG. 9 illustrates, in block diagram form, exemplary processing system 900 to implement lockstep networking. Data processing system 900 includes one or more microprocessors 905 and connected system components (e.g., multiple connected chips). Alternatively, data processing system 900 is a system on a chip.

Data processing system 900 includes memory 910, which is coupled to microprocessor(s) 905. Memory 910 may be used for storing data, metadata, and programs for execution by the microprocessor(s) 905. Memory 910 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 910 may be internal or distributed memory.

Data processing system 900 includes one or more network or port interfaces 915, such as a port, connector for a dock, or a connector for a USB interface, FireWire, Thunderbolt, Ethernet, Fibre Channel, etc. to connect the system 900 with another device, external component, or a network. Exemplary network and port interfaces 915 also include wireless transceivers, such as an IEEE 802.11 transceiver, an IEEE 802.15.4 transceiver, an infrared transceiver, a Bluetooth transceiver, a wireless cellular telephony transceiver (e.g., 2G, 3G, 4G, etc.), or another wireless protocol to connect data processing system 900 with another device, external component, or a network and receive stored instructions, data, tokens, etc.

In one embodiment, data processing system 900 also includes display controller and display device 920 and one or more input or output (“I/O”) devices and interfaces 925. Display controller and display device 920 provides a visual user interface for the user. In one embodiment, I/O devices include one or more sensors to measure moisture, light, electrical conductivity, movement, etc. In one embodiment, I/O devices 925 allow a user to provide input to, receive output from, and otherwise transfer data to and from the system. I/O devices 925 may include a mouse, keypad or a keyboard, a touch panel or a multi-touch input panel, camera, optical scanner, audio input/output (e.g., microphone and/or a speaker), other known I/O devices or a combination of such I/O devices.

It will be appreciated that one or more buses, may be used to interconnect the various components shown in FIG. 9.

Data processing system 900 is an exemplary representation of one or more of base station 105, field devices 110-135, server 150, storage 155, or user device 160 described above. Data processing system 900 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, data processing system 900 may be a network computer, server, or an embedded processing device within another device or consumer electronic product. As used herein, the terms computer, device, system, processing system, processing device, and “apparatus comprising a processing device” may be used interchangeably with data processing system 900 and include the above-listed exemplary embodiments.

It will be appreciated that additional components, not shown, may also be part of data processing system 900, and, in certain embodiments, fewer components than that shown in FIG. 9 may also be used in data processing system 900. It will be apparent from this description that aspects of the inventions may be embodied, at least in part, in software. That is, the computer-implemented methods 300, 400, and 500 may be carried out in a computer system or other data processing system 900 in response to its processor or processing system 905 executing sequences of instructions contained in a memory, such as memory 910 or other non-transitory machine-readable storage medium. The software may further be transmitted or received over a network (not shown) via network interface device 915. In various embodiments, hardwired circuitry may be used in combination with the software instructions to implement the present embodiments. Thus, the techniques are not limited to any specific combination of hardware circuitry and software, or to any particular source for the instructions executed by data processing system 900.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. References in the specification to “one embodiment,” “an embodiment,” “an exemplary embodiment,” etc., indicate that the embodiment described may include a particular feature, structure, or characteristic, but not every embodiment may necessarily include the particular feature, structure, or characteristic. Moreover, such phrases are not necessarily referring to the same embodiment. Furthermore, when a particular feature, structure, or characteristic is described in connection with an embodiment, such feature, structure, or characteristic may be implemented in connection with other embodiments whether or not explicitly described. Additionally, as used herein, the term “exemplary” refers to embodiments that serve as simply an example or illustration. The use of exemplary should not be construed as an indication of preferred examples. Blocks with dashed borders (e.g., large dashes, small dashes, dot-dash, dots) are used herein to illustrate optional operations that add additional features to embodiments of the invention. However, such notation should not be taken to mean that these are the only options or optional operations, and/or that blocks with solid borders are not optional in certain embodiments of the invention. Numerous specific details are described to provide a thorough understanding of various embodiments of the present invention. However, in certain instances, well-known or conventional details are not described in order to provide a concise discussion of embodiments of the present inventions.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

1. A computer-implemented method, comprising:
configuring, by a first field device, a recurring heartbeat period to run in synchronization with a second field device and a base station based upon a clock synchronized with the base station and based upon a heartbeat interval synchronized with the base station;
turning off, by the first field device, power to a transmit radio and power to a receive radio as a part of a hibernation period to expire at a beginning of a heartbeat of the recurring heartbeat period;
ending the hibernation period at the beginning of the heartbeat;
sampling, by the first field device, a first sensor value at the beginning of the heartbeat;
storing, by the first field device, a first report in a report buffer, the first report including the first sensor value, an identification of the first field device, an identification of the first report, and a first circle number representing a number of intervening field devices in a communication path between the first field device and the base station;
turning on, by the first field device, power to the receive radio;
receiving, by the first field device via the receive radio during a first waiting period, a second report from the second field device, the second report including a second sensor value, an identification of the second field device, an identification of the second report, and a second circle number representing a number of intervening field devices in a communication path between the second field device and the base station;
transmitting, by the first field device via the transmit radio, one or more reports stored in the report buffer, the one or more reports including the first report; and
turning off, by the first field device, power to the transmit radio and power to the receive radio as a part of a hibernation period beginning at an expiration of the heartbeat and to expire at a beginning of a next heartbeat of the recurring heartbeat period.

2. The computer-implemented method of claim 1, further comprising:
receiving, by the first field device from the base station, an indication of time and an indication of the heartbeat interval; and
configuring, by the first field device, the clock to run in synchronization with the second field device and the base station based upon the indication of time received from the base station, wherein configuring the recurring heartbeat period is based upon the indication of the heartbeat interval.

3. The computer-implemented method of claim 1, wherein the first waiting period is a multiple of one or more predetermined wait intervals in length based upon the first circle number.

4. The computer-implemented method of claim 3, wherein the multiple of one or more predetermined wait intervals is based upon a maximum circle number received in a previous acknowledgment from the base station.

5. The computer-implemented method of claim 1, further comprising:
adding, by the first field device during the heartbeat, the second report to the report buffer when the first field device determines, based upon the identification of the second field device and the identification of the second report, the second report has not been previously received by the first field device during the heartbeat and when the first field device determines the second circle number is greater than the first circle number; and
discarding, by the first field device during the heartbeat, the second report when the first field device determines the second circle number is less than or equal to the first circle number or when the first field device determines, based upon the identification of the second field device and the identification of the second report, the second report has been previously received by the first field device during the heartbeat.

6. The computer-implemented method of claim 1, further comprising:
discarding, by the first field device during the heartbeat, any reports stored in the report buffer received from other field devices in response to transmitting the one or more reports.

7. The computer-implemented method of claim 1, further comprising:
receiving, by the first field device during a second waiting period, an acknowledgment from the base station of the first report;
discarding, by the first field device, the first report in response to receiving the acknowledgment from the base station of the first report; and
transmitting, by the first device, any acknowledgments from the base station of other reports.

8. The computer-implemented method of claim 7, wherein the second waiting period is one or more predetermined wait intervals in length based upon the first circle number.

9. The computer-implemented method of claim 7, further comprising:
updating the first circle number based upon a hop count determined from data received with the acknowledgment of the first report.

10. The computer-implemented method of claim 7, further comprising:
updating the clock based upon data received with the acknowledgment of the first report.

11. The computer-implemented method of claim 1, wherein the second report includes a maximum circle number, the method further comprising:
comparing the maximum circle number received in the second report to a maximum circle number received in a previous acknowledgment or another report; and
adding a greater of the maximum circle numbers in the first report.

12. The computer-implemented method of claim 1, further comprising:
determining the field device did not receive an acknowledgment from the base station during a second waiting period; and
modifying the heartbeat period in response to not receiving the acknowledgement.

13. The computer-implemented method of claim 1, further comprising:
determining the field device did not receive an acknowledgment from the base station during a second waiting period;
determining the field device received one or more reports from one or more other field devices within a threshold period of time during which the reports were expected to be received based upon the heartbeat interval; and
determining the heartbeat period is in synchronization with the one or more other field devices in response to determining the one or more reports from one or more other field devices were received within the threshold period of time during which the reports were expected to be received.

14. A non-transitory computer-readable medium storing instructions, which when executed by a processing device, cause the processing device to perform a method comprising:
configuring, by a first field device, a recurring heartbeat period to run in synchronization with a second field device and a base station based upon a clock synchronized with the base station and based upon a heartbeat interval synchronized with the base station;
turning off, by the first field device, power to a transmit radio and power to a receive radio as a part of a hibernation period to expire at a beginning of a heartbeat of the recurring heartbeat period;
ending the hibernation period at the beginning of the heartbeat;
sampling, by the first field device, a first sensor value at the beginning of the heartbeat;
storing, by the first field device, a first report in a report buffer, the first report including the first sensor value, an identification of the first field device, an identification of the first report, and a first circle number representing a number of intervening field devices in a communication path between the first field device and the base station;
turning on, by the first field device, power to the receive radio;
receiving, by the first field device via the receive radio during a first waiting period, a second report from the second field device, the second report including a second sensor value, an identification of the second field device, an identification of the second report, and a second circle number representing a number of intervening field devices in a communication path between the second field device and the base station;
transmitting, by the first field device via the transmit radio, one or more reports stored in the report buffer, the one or more reports including the first report; and
turning off, by the first field device, power to the transmit radio and power to the receive radio as a part of a hibernation period beginning at an expiration of the heartbeat and to expire at a beginning of a next heartbeat of the recurring heartbeat period.

15. The non-transitory computer-readable medium of claim 14, the method further comprising:
receiving, by the first field device from the base station, an indication of time and an indication of the heartbeat interval; and
configuring, by the first field device, the clock to run in synchronization with the second field device and the base station based upon the indication of time received from the base station, wherein configuring the recurring heartbeat period is based upon the indication of the heartbeat interval.

16. The non-transitory computer-readable medium of claim 14, wherein the first waiting period is a multiple of one or more predetermined wait intervals in length based upon the first circle number.

17. The non-transitory computer-readable medium of claim 16, wherein the multiple of one or more predetermined wait intervals is based upon a maximum circle number received in a previous acknowledgment from the base station.

18. The non-transitory computer-readable medium of claim 14, the method further comprising:
adding, by the first field device during the heartbeat, the second report to the report buffer when the first field device determines, based upon the identification of the second field device and the identification of the second report, the second report has not been previously received by the first field device during the heartbeat and when the first field device determines the second circle number is greater than the first circle number; and
discarding, by the first field device during the heartbeat, the second report when the first field device determines the second circle number is less than or equal to the first circle number or when the first field device determines, based upon the identification of the second field device and the identification of the second report, the second report has been previously received by the first field device during the heartbeat.

19. The non-transitory computer-readable medium of claim 14, the method further comprising:
discarding, by the first field device during the heartbeat, any reports stored in the report buffer received from other field devices in response to transmitting the one or more reports.

20-26. (canceled)

27. A field device comprising:
a processing device; and
a memory coupled to the processing device, the memory storing instructions which, when executed by the processing device, cause the field device to:
configure a recurring heartbeat period to run in synchronization with a second field device and a base station based upon a clock synchronized with the base station and based upon a heartbeat interval synchronized with the base station;
turn off power to a transmit radio and power to a receive radio as a part of a hibernation period to expire at a beginning of a heartbeat of the recurring heartbeat period;
end the hibernation period at the beginning of the heartbeat;
sample a first sensor value at the beginning of the heartbeat;
store a first report in a report buffer, the first report including the first sensor value, an identification of the first field device, an identification of the first report, and a first circle number representing a number of intervening field devices in a communication path between the first field device and the base station;
turn on power to the receive radio;
receive, via the receive radio during a first waiting period, a second report from the second field device, the second report including a second sensor value, an identification of the second field device, an identification of the second report, and a second circle number representing a number of intervening field devices in a communication path between the second field device and the base station;
transmit, via the transmit radio, one or more reports stored in the report buffer, the one or more reports including the first report; and
turn off power to the transmit radio and power to the receive radio as a part of a hibernation period beginning at an expiration of the heartbeat and to expire at a beginning of a next heartbeat of the recurring heartbeat period.
